(19) United States
(12) Patent Application Publication
(10) Pub. No.: US 2023/0020308 A1
(43) Pub. Date: Jan. 19, 2023

(54) SEALANT COMPOSITION

(71) Applicant: THE YOKOHAMA RUBBER CO., LTD., MINATO-KU, TOKYO (JP)

(72) Inventor: Kiyohito TAKAHASHI, HIRATSUKA SHI, KANAGAWA (JP)

(21) Appl. No.: 17/784,765

(22) PCT Filed: Dec. 17, 2020
(86) PCT No.: PCT/JP2020/047177

§ 371 Date: Jun. 13, 2022

(30) Foreign Application Priority Data
Dec. 17, 2019 (JP) 2019-227729
Dec. 17, 2019 (JP) 2019-227730

(51) Int. Cl. C09K 3/10

(52) U.S. Cl. CPC C09K 3/1006; C09K 2003/1068; C09K 2003/1034

(57) ABSTRACT

Provided is a sealant composition that makes it possible to suppress a flow of a sealant associated with travel while maintaining good sealing properties. As a sealant composition constituting a sealant layer (10) disposed on the inner surface of a pneumatic tire, the following are used: a sealant composition demonstrating a tensile stress at 20% elongation at 23° C. of 0.03 MPa or less and a tensile stress at 20% elongation at 80° C. of 0.002 MPa; or a sealant composition demonstrating a viscosity V₀ at 0° C. of from 2 kPa·s to 15 kPa s, a viscosity V₄₀ at 40° C. of from 1 kPa s to 14 kPa s, and a viscosity V₈₀ at 80° C. of from 0.5 kPa·s to 12 kPa·s.

### TECHNICAL FIELD

The present invention relates to a sealant composition forming a sealant layer of a self-sealing type pneumatic tire including the sealant layer in a tire inner surface.

### BACKGROUND ART

In a known pneumatic tire, a sealant layer is provided in an inner side in a tire radial direction of an innerliner layer in a tread portion (for example, see Patent Document 1). In such a pneumatic tire, when a foreign matter such as a nail sticks into the tread portion, a sealant constituting the sealant layer flows into a through-hole made by the foreign matter, and accordingly, a decrease in air pressure can be suppressed and travel can be maintained.

In the self-sealing type pneumatic tire described above, when the viscosity of the sealant is lower, since the sealant easily flows into the through-hole, improvement of sealing properties can be expected, but in a case where the sealant flows toward a tire center side due to the effects of heat and centrifugal force applied during travel, and as a result, the through-hole deviates from a tire center region, there is concern that the sealant becomes insufficient and sealing properties cannot be obtained sufficiently. On the other hand, when the viscosity of the sealant is high, a flow of the sealant described above can be prevented, but the sealant becomes difficult to flow into the through-hole, and there is concern that the sealing properties decrease. Thus, there is a demand that a sealant composition constituting a sealant provides suppression of a flow of a sealant associated with travel and ensuring of good sealing properties in a well-balanced, compatible manner.

### CITATION LIST

### Patent Literature

Patent Document 1: JP 2006-152110 A

### SUMMARY OF INVENTION

### Technical Problem

An object of the present invention is to provide a sealant composition that makes it possible to suppress a flow of a sealant associated with travel while maintaining good sealing properties.

### Solution to Problem

A first sealant composition according to an embodiment of the present invention to achieve the object described above is a sealant composition constituting a sealant layer disposed on an inner surface of a pneumatic tire, the sealant composition demonstrating a tensile stress M₂₃ at 20% elongation at 23° C. of 0.03 MPa or less and a tensile stress M₈₀ at 20% elongation at 80° C. of 0.002 MPa or more.

A second sealant composition according to an embodiment of the present invention to achieve the object described above demonstrates a viscosity V₀ at 0° C. of from 2 kPa·s to 15 kPa·s, a viscosity V₄₀ at 40° C. of from 1 kPa·s to 14 kPa·s, and a viscosity V₈₀ at 80° C. of from 0.5 kPa·s to 12 kPa·s.

### Advantageous Effects of Invention

Since a first sealant composition according to an embodiment of the present invention satisfies the characteristics described above (relationship with tensile stress at 20% elongation at specific temperatures), the first sealant composition can exhibit good sealing properties while suppressing a flow of the sealant associated with travel. In particular, by setting the tensile stress M₂₃ at 20% elongation at 23° C. to 0.03 MPa or less, proper viscosity and flexibility can be ensured, exhibiting good sealing properties. Furthermore, by setting the tensile stress M₈₀ at 20% elongation at 80° C. to 0.002 MPa or more, a flow of the sealant associated with travel can be suppressed. In particular, by allowing the tensile stress at 20% elongation at each temperature to be in a proper range, the sealant tends to follow the deflection during travel, and both the effect of improving the sealing properties and the effect of suppressing the fluidity can be effectively enhanced. Note that, in an embodiment of the present invention, “tensile stress at 20% elongation” is a value measured by performing tensile testing in accordance with JIS K 6251 using a JIS No. 3 dumbbell-shaped test piece at a pulling speed of 500 mm/min under each designated temperature condition (23° C. or 80° C.).

Since a second sealant composition according to an embodiment of the present invention satisfies the characteristics described above (relationship with viscosities at specific temperatures), the second sealant composition can exhibit good sealing properties while a flow of the sealant associated with travel is suppressed. In addition, the effect of exhibiting good sealing properties even under a low temperature environment, and also the effect of suppressing a flow of the sealant even during storage can be expected. In particular, by setting the viscosity V₀ at 0° C. to 2 kPa·s to 15 kPa·s, hardening of the sealant in a low temperature environment can be prevented, maintaining proper viscosity and flexibility, and thus can good sealing properties be ensured also in a low temperature environment. Furthermore, by setting the viscosity V₄₀ at 40° C. to 1 kPa·s to 14 kPa s, proper elasticity can be obtained in such a temperature condition that is close to storage conditions, a flow of the sealant can be suppressed during tire storage, which enhances the storage performance. Furthermore, by setting the viscosity V₈₀ at 80° C. to 0.5 kPa·s to 12 kPa·s, proper elasticity can be obtained also in a high temperature condition, a flow of the sealant associated with travel can be effectively suppressed. In particular, because the proper viscosity that can exhibits these performances in a well-balanced manner can be maintained regardless of the temperature, sealing properties in low temperature environments, storage performance, and fluidity can be provided in a well-balanced and highly compatible manner. Note that, in an embodiment of the present invention, “viscosity” is a value measured by using a rotational rheometer with a sample having a diameter of 25 mm and a thickness of 1.5 mm under the conditions of: an amount of deformation of 0.1%; and a frequency of 1 Hz, at each designated temperature condition (0° C., 40° C., 80° C.).

The first sealant composition according to an embodiment of the present invention preferably has M₂₃/M₈₀, a ratio of the tensile stress M₂₃ at 20% elongation at 23° C. to the tensile stress M₈₀ at 20% elongation at 80° C., of 2.0 or less. With the difference in the tensile stresses at different temperatures being small in this manner, the effect on the physical properties of the sealant due to the temperature change (e.g., increase in a tire temperature during travel) can be suppressed, making it advantageous to provide the improvement of the sealing properties and the suppression of a flow of the sealant associated with travel in a compatible manner.

The second sealant composition according to an embodiment of the present invention preferably has V₀/V₄₀, a ratio of the viscosity V₀ at 0° C. to the viscosity V₄₀ at 40° C., of 5 or less. Furthermore, V₀/V₈₀, a ratio of the viscosity V₀ at 0° C. to the viscosity V₈₀ at 80° C., is preferably 10 or less. Allowing the small difference in the viscosities at different temperature conditions as described above makes it advantageous to provide sealing properties in low temperature environments, storage performance, and fluidity in a well-balanced, compatible manner.

Both of the first and second sealant compositions according to an embodiment of the present invention preferably contain from 50 parts by mass to 400 parts by mass of paraffin oil per 100 parts by mass of the rubber component. Furthermore, the molecular weight of the paraffin oil is preferably 800 or more. This can lower the temperature dependency of the physical properties of the sealant composition, and the physical properties described above (tensile stress at 20% elongation and viscosity) can be easily imparted to the sealant, making it advantageous to provide the improvement of sealing properties (sealing properties at room temperature and in low temperature environments) and the suppression of a flow of the sealant associated with travel in a compatible manner.

Both of the first and second sealant compositions according to an embodiment of the present invention preferably contain from 1 part by mass to 40 parts by mass of organic peroxide, from 0.1 parts by mass to 40 parts by mass of crosslinking agent, and more than 0 parts by mass and less than 1 part by mass of crosslinking aid per 100 parts by mass of the rubber component. By performing crosslinking using a blend of the crosslinking agent and the organic peroxide in combination as described above, a proper elasticity that does not allow a flow during travel or storage can be achieved while adequate viscosity to achieve good sealing properties is ensured, and thus this is advantageous to provide these performances in a well-balanced, compatible manner. Furthermore, such a blend can lower the temperature dependency of the physical properties of the sealant composition, and makes it advantageous to provide sealing properties in low temperature environments, storage performance, and fluidity in a well-balanced, compatible manner.

In the first and second sealant compositions according to an embodiment of the present invention, the crosslinking agent preferably contains a sulfur component. This increases the reactivity of the rubber component (e.g., butyl rubber) with the crosslinking agent (sulfur) and the organic peroxide, and thus the processability of the sealant composition can be improved.

In the first and second sealant compositions according to an embodiment of the present invention, the blended amount of the crosslinking agent is preferably from 50 mass % to 400 mass % of the blended amount of the crosslinking aid. In this way, good balance between the crosslinking agent and the crosslinking aid is achieved, and thus can heat degradation be suppressed, maintaining good sealing properties for a long term.

In the first and second sealant compositions according to an embodiment of the present invention, the crosslinking aid is preferably a thiazole-based compound or a thiuram-based compound. This allows the vulcanization rate to be increased, which can enhance productivity. Meanwhile, heat degradation can be suppressed more than other crosslinking aids, and good sealing properties can be maintained for a long term.

In the first and second sealant compositions according to an embodiment of the present invention, the rubber component preferably contains butyl rubber, and the blended amount of the butyl rubber is preferably 10 mass % or more per 100 mass % of the rubber component. Further, the butyl rubber preferably includes chlorinated butyl rubber, and a blended amount of the chlorinated butyl rubber per 100 mass % of the rubber component is preferably 5 mass % or more. According to such a blend, adhesiveness with respect to the tire inner surface can improve.

In a pneumatic tire including the sealant layer containing the first and second sealant compositions according to an embodiment of the present invention described above, due to excellent physical properties of the sealant compositions described above, good sealing properties can be exhibited while a flow of the sealant associated with travel is suppressed.

### BRIEF DESCRIPTION OF DRAWINGS

FIG. 1 is a meridian cross-sectional view illustrating an example of a pneumatic tire of an embodiment of the present invention.

### DESCRIPTION OF EMBODIMENTS

Configurations of embodiments of the present invention will be described in detail below with reference to the accompanying drawings.

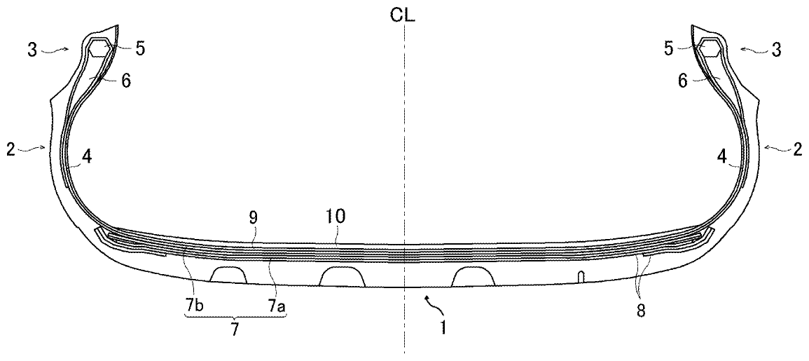

As illustrated in FIG. 1 for example, a pneumatic tire (self-sealing type pneumatic tire) of an embodiment of the present invention includes a tread portion 1 extending in a tire circumferential direction and having an annular shape, a pair of sidewall portions 2 disposed on both sides of the tread portion 1, and a pair of bead portions 3 disposed on an inner side in a tire radial direction of the sidewall portions 2. Note that “CL” in FIG. 1 denotes a tire equator. Note that FIG. 1 is a meridian cross-sectional view, and although not illustrated, the tread portion 1, the sidewall portions 2, and the bead portions 3 each extend in the tire circumferential direction and each have an annular shape, and accordingly, a basic structure of a toroidal shape of the pneumatic tire is formed. Other tire components in the meridian cross-sectional view also extend in the tire circumferential direction to form annular shapes unless otherwise indicated.

In the example of FIG. 1, a carcass layer 4 is mounted between the pair of bead portions 3 of left and right. The carcass layer 4 includes a plurality of reinforcing cords extending in the tire radial direction, and is folded back around a bead core 5 and a bead filler 6 disposed in each of the bead portions 3 from a vehicle inner side to a vehicle outer side. Additionally, the bead filler 6 is disposed on an outer circumferential side of the bead core 5, and the bead filler 6 is enveloped by a body portion and a folded back portion of the carcass layer 4.

A plurality of belt layers 7 (two layers in FIG. 1) are embedded on an outer circumferential side of the carcass layer 4 in the tread portion 1. Among the plurality of belt layers 7, a layer having the smallest belt width is referred to as a minimum belt layer 7a, and a layer having the largest belt width is referred to as a maximum belt layer 7b. The belt layers 7 each include a plurality of reinforcing cords inclining with respect to the tire circumferential direction, and are disposed such that the reinforcing cords of the different layers intersect each other. In these belt layers 7, the inclination angle of the reinforcing cords with respect to the tire circumferential direction is set in a range of, for example, 10° or more and 40° or less. A belt reinforcing layer 8 is provided on an outer circumferential side of the belt layers 7 in the tread portion 1. In the illustrated example, the belt reinforcing layer 8 is provided including two layers of a full cover layer covering the entire width of the belt layer 7 and an edge cover layer disposed further on an outer circumferential side than the full cover layer and covering only an end portion of the belt layer 7. The belt reinforcing layer 8 includes an organic fiber cord oriented in the tire circumferential direction, and an angle of the organic fiber cord with respect to the tire circumferential direction is set to be, for example, from 0° to 5°.

In a tire inner surface, an innerliner layer 9 is provided along the carcass layer 4. Innerliner layer 9 is a layer for preventing air in the tire from permeate outside the tire. The innerliner layer 9 includes, for example, a rubber composition including, as a main component, butyl rubber having air permeation preventing performance. Alternatively, the innerliner 9 can also include a resin layer including a thermoplastic resin as a matrix. In the case of the resin layer, a resin layer including an elastomer component dispersed in a matrix of a thermoplastic resin may be used.

As illustrated in FIG. 1, a sealant layer 10 is provided on an inner side in the tire radial direction of the innerliner layer 9 in the tread portion 1. Particularly, the sealant layer 10 is provided in the tire inner surface corresponding to a region into which a foreign matter such as a nail may stick during travel, that is, a ground contact region of the tread portion 1. Particularly, the sealant layer 10 may be provided in the range wider than the width of the minimum belt layer 7a. A sealant composition of an embodiment of the present invention is used in the sealant layer 10. Sealant layer 10 is a layer attached to the inner surface of the pneumatic tire including the basic structure described above, and for example, when a foreign matter such as a nail sticks into the tread portion 1, a sealant constituting the sealant layer 10 flows into a through-hole made by the foreign matter and seals the through-hole, and accordingly, a decrease in air pressure can be suppressed and travel can be maintained.

The sealant layer 10 has a thickness of, for example, from 0.5 mm to 5.0 mm. The sealant layer 10 has this degree of thickness, and accordingly, a flow of a sealant during travel can be suppressed while ensuring good sealing properties. Additionally, good processability at the time of attaching the sealant layer 10 to the tire inner surface is also obtained. When the thickness of the sealant layer 10 is less than 0.5 mm, it becomes difficult to ensure sufficient sealing properties. When the thickness of the sealant layer 10 exceeds 5.0 mm, tire weight increases and rolling resistance degrades. Note that thickness of sealant layer 10 refers to the average thickness.

The sealant layer 10 can be formed by attaching later the sealant layer 10 to the inner surface of the vulcanized pneumatic tire. For example, the sealant layer 10 can be formed by attaching a sealant including the sealant composition described below and molded in a sheet shape to the entire circumference of the tire inner surface, or by spirally attaching a sealant including the sealant composition described below and molded in a string-like shape or a band-like shape to the tire inner surface. Additionally, at this time, the sealant composition is heated, and accordingly, variation in the performance of the sealant composition can be suppressed. As heating conditions, temperature may be preferably from 140° C. to 180° C., and more preferably from 160° C. to 180° C., and heating time may be preferably from 5 minutes to 30 minutes, and more preferably from 10 minutes to 20 minutes. According to the method of manufacturing the pneumatic tire, the pneumatic tire that provides good sealing properties at the time of puncture and that is difficult to generate a flow of the sealant can be manufactured efficiently.

An embodiment of the present invention mainly relates to the sealant composition used in the sealant layer 10 of the self-sealing type pneumatic tire described above, and thus the basic structure of the pneumatic tire and the structure of the sealant layer 10 are not limited to the examples described above.

In the sealant layer 10 described above, when the viscosity of the sealant constituting the sealant layer 10 is lower, improvement of sealing properties can be expected, as the sealant easily flows into a through-hole; however, in a case where the sealant flows toward a tire center side due to the effects of heat and centrifugal force applied during travel, and as a result, the through-hole deviates from a tire center region, there is concern that the sealant becomes insufficient and sealing properties cannot be obtained sufficiently. On the other hand, when the viscosity of the sealant is high, a flow of the sealant described above can be prevented, but the sealant becomes difficult to flow into the through-hole, and there is concern that the sealing properties decrease. Thus, there is a demand that a sealant composition constituting a sealant provides suppression of a flow of a sealant associated with travel and ensuring of good sealing properties in a well-balanced, compatible manner.

From such perspectives, the tensile stress M₂₃ at 20% elongation at 23° C. of the first sealant composition according to an embodiment of the present invention is set to 0.03 MPa or less, and preferably from 0.005 MPa to 0.02 MPa. At the same time, the tensile stress M₈₀ at 20% elongation at 80° C. is set to 0.002 MPa or more, and preferably from 0.005 MPa to 0.01 MPa. In a case where the sealant composition having such characteristics is used for the sealant layer 10 of the pneumatic tire, good sealing properties can be exhibited while a flow of the sealant associated with travel is effectively suppressed. In particular, by allowing each of the tensile stresses M₂₃ and M₈₀ at 20% elongation at each temperature to be in a proper range, the sealant tends to follow the deflection during travel, and both the effect of improving the sealing properties and the effect of suppressing the fluidity can be effectively enhanced. When the tensile stress M₂₃ at 20% elongation at 23° C. is more than 0.03 MPa, adequate viscosity and flexibility cannot be ensured, and good sealing properties cannot be exhibited. When the tensile stress M₈₀ at 20% elongation at 80° C. is less than 0.002 MPa, a flow of the sealant associated with travel cannot be suppressed.

In the first sealant composition according to an embodiment of the present invention, it is important for each of the tensile stresses M₂₃ and M₈₀ at 20% elongation at different temperatures described above to be in appropriate ranges described above. That is, each of the physical properties at different temperatures being appropriate leads to the suppression of the effect on the physical properties of the sealant due to the temperature change (e.g., increase in the tire temperature during travel), and thus it is advantageous to provide the improvement of the sealing properties and the suppression of a flow of the sealant associated with travel in a compatible manner. Specifically, the ratio M₂₃/M₈₀ of the tensile stress M₂₃ at 20% elongation at 23° C. to the tensile stress M₈₀ at 20% elongation at 80° C. is preferably 2.0 or less, and more preferably from 1.0 to 1.5. With the difference in the tensile stresses M₂₃ and M₈₀ at different temperatures being small as described above, the effect of the temperature on the physical properties of the sealant is suppressed, making it advantageous to provide the improvement of the sealing properties and the suppression of a flow of the sealant associated with travel in a compatible manner. When the ratio M₂₃/M₈₀ is more than 2.0, it becomes difficult to provide the performances described above in a well-balanced, compatible manner.

The sealant composition is required to provide improvement of sealing properties and suppression of a flow of the sealant associated with travel in a compatible manner as described above; however, in addition to this, it is preferably taken into consideration that the viscosity of the sealant has temperature dependency, and the viscosity tends to be higher as the temperature is lower. That is, due to this temperature dependency, in a low temperature environment such as a case of use in winter or in a cold region, the viscosity of the sealant may become high, and the sealing properties may be impaired. Furthermore, because the sealant is solidified due to the temperature condition, when a foreign material, such as a nail, is stuck in the tread portion, a part of the sealant around the through-hole may be lost by the impact, and the through-hole may be not sealed properly. Therefore, the sealant composition constituting the sealant is also required to exhibit good sealing properties also in a low temperature environment.

Furthermore, as another perspective, regarding a flow of the sealant, in addition to during travel described above, also in a case where a tire is stored for a long term in a condition where a sealant layer is provided, there is concern that the sealant may gradually flow toward the tire center side during the storage. Therefore, suppression of a flow (achieving good storage performance) is required also in a case where the sealant is allowed to stand still for a long term in predetermined conditions.

Taking the points described above into consideration, in the second sealant composition according to an embodiment of the present invention, the viscosity V₀ at 0° C. is set to from 2 kPa·s to 15 kPa·s, and preferably from 3 kPa·s to 10 kPa·s. Meanwhile, the viscosity V₄₀ at 40° C. is set to from 1 kPa·s to 14 kPa·s, and preferably from 2 kPa·s to 8 kPa·s. In addition, the viscosity V₈₀ at 80° C. is set to from 0.5 kPa·s to 12 kPa·s, and preferably from 1 kPa·s to 6 kPa s. When used in a sealant layer 10 of a pneumatic tire, the sealant composition having such characteristics can exhibit good sealing properties also in a low temperature environment in addition to exhibiting good sealing properties while a flow of the sealant associated with travel is suppressed and, in addition, a flow of the sealant is also suppressed during storage, and these performances can be provided in a well-balanced, compatible manner. In particular, the physical properties (viscosities) at different temperatures being proper leads to a smaller effect of the temperature on the physical properties of the sealant, and because the proper viscosity that can exhibits these performances in a well-balanced manner can be maintained regardless of the temperature, sealing properties in low temperature environments, storage performance, and fluidity can be provided in a well-balanced and highly compatible manner.

At this time, when the viscosity V₀ at 0° C. is less than 2 kPa·s, fluidity is degraded, and when the viscosity V₀ at 0° C. is more than 15 kPa·s, sealing properties in a low temperature environment is degraded. When the viscosity V₄₀ at 40° C. is less than 1 kPa s, a flow in the sealant during storage cannot be adequately suppressed, and the storage performance is degraded. When the viscosity V₄₀ at 40° C. is more than 14 kPa s, sealing properties are degraded. When the viscosity V₈₀ at 80° C. is less than 0.5 kPa s, fluidity of the sealant during travel is degraded, and when the viscosity V₈₀ at 80° C. is more than 12 kPa s, sealing properties are degraded.

In the second sealant composition according to an embodiment of the present invention, as described above, it is important for each of the viscosities at different temperatures to be in each appropriate range described above. In particular, the ratio V₀/V₄₀ of the viscosity V₀ at 0° C. to the viscosity V₄₀ at 40° C. is preferably 5 or less, and more preferably from 1.0 to 3.0. With the difference in the viscosity at a low temperature (0° C.) and the viscosity at a moderate temperature condition (40° C.) being small as described above, sealing properties in a low temperature environment and a storage performance can be provided in a well-balanced, compatible manner. At this time, when the ratio V₀/V₄₀ is more than 5, because the difference in the viscosities due to the temperature conditions becomes greater, making it difficult to provide the sealing properties in a low temperature environment and the storage performance in a well-balanced, compatible manner.

Similarly, in the sealant composition according to an embodiment of the present invention, the ratio V₀/V₈₀ of the viscosity V₀ at 0° C. to the viscosity V₈₀ at 80° C. is preferably 10 or less, and more preferably from 1.0 to 5.0. With the difference in the viscosity at a low temperature (0° C.) and the viscosity at a high temperature (80° C.) being small as described above, the sealing properties in a low temperature environment and the fluidity during travel can be provided in a well-balanced, compatible manner. At this time, when the ratio V₀/V₈₀ is more than 10, because the difference in the viscosities due to the temperature conditions widens, making it difficult to provide the sealing properties in a low temperature environment and the fluidity during travel in a well-balanced, compatible manner.

Note that, in a case where physical properties defined for the first and second sealant compositions according to an embodiment of the present invention (a relationship of tensile stresses at 20% elongation at specific temperatures and a relationship of viscosities at specific temperatures) are simultaneously satisfied, both of the effects expected from the physical properties can be exhibited. Furthermore, also in a case of the first sealant composition, by satisfying the preferred range described above of the tensile stress at 20% elongation at each of the temperatures, effect of enhancing the sealing properties in a low temperature environment and the storage performance can be expected.

As long as the sealant composition used in an embodiment of the present invention has the physical properties described above, a specific blend of the sealant composition is not particularly limited. However, to reliably obtain the physical properties described above, for example, a blend described below is preferably employed.

In the sealant composition of an embodiment of the present invention, a rubber component may include butyl rubber. A proportion of the butyl rubber in the rubber component is preferably 10 mass % or more, more preferably from 20 mass % to 90 mass %, and even more preferably from 30 mass % to 90 mass %. Good adhesiveness with respect to the tire inner surface can be ensured by including the butyl rubber in this manner. When the proportion of the butyl rubber is less than 10 mass %, adhesiveness with respect to the tire inner surface cannot be ensured sufficiently.

In particular, in the range described above, because the butyl rubber tends to reduce the tensile stress at 20% elongation at 23° C. when the blended amount thereof is greater and tends to increase the tensile stress at 20% elongation at 23° C. when the blended amount thereof is smaller, setting the proportion of the butyl rubber to the more preferred range (from 20 mass % to 90 mass %) or even more preferred range (from 30 mass % to 90 mass %) described above is effective to set the tensile stress at 20% elongation (especially, tensile stress at 20% elongation at 23° C.) to the proper range specified in an embodiment of the present invention. Similarly, in the range described above, because the butyl rubber tends to reduce the viscosity at 0° C. when the blended amount thereof is greater and tends to increase the viscosity at 0° C. when the blended amount thereof is smaller, setting the proportion of the butyl rubber to the more preferred range (from 20 mass % to 90 mass %) or even more preferred range (from 30 mass % to 90 mass %) described above is effective to set the viscosity (especially, viscosity at 0° C.) to the proper range specified in an embodiment of the present invention.

The sealant composition of an embodiment of the present invention preferably includes, as the butyl rubber, halogenated butyl rubber. Among the butyl rubbers, halogenated butyl rubber is effective to achieve the physical properties described above. Examples of the halogenated butyl rubber include chlorinated butyl rubber and brominated butyl rubber, and particularly, chlorinated butyl rubber can be used suitably. In a case where chlorinated butyl rubber is used, a proportion of the chlorinated butyl rubber per 100 mass % of the rubber component is preferably 5 mass % or more, more preferably from 10 mass % to 85 mass %, and even more preferably from 30 mass % to 70 mass %. Reactivity of the rubber component and a crosslinking agent or an organic peroxide described below increases by including the halogenated butyl rubber (chlorinated butyl rubber), and this is advantageous in that ensuring of sealing properties and suppression of a flow of the sealant are provided in a compatible manner. Additionally, the processability of the sealant composition can also improve. When the proportion of the chlorinated butyl rubber is less than 5 mass %, reactivity of the rubber component and the crosslinking agent or the organic peroxide described below does not improve sufficiently, and a desired effect cannot be obtained sufficiently.

In particular, in the range described above, because the chlorinated butyl rubber tends to reduce the tensile stress at 20% elongation at 23° C. when the blended amount thereof is greater and tends to increase the tensile stress at 20% elongation at 23° C. when the blended amount thereof is smaller, setting the proportion of the chlorinated butyl rubber to the more preferred range (from 20 mass % to 90 mass %) or even more preferred range (from 30 mass % to 70 mass %) described above is effective to set the tensile stress at 20% elongation (especially, tensile stress at 20% elongation at 23° C.) to the proper range specified in an embodiment of the present invention. Similarly, in the range described above, because the chlorinated butyl rubber tends to reduce the viscosity at 0° C. when the blended amount thereof is greater and tends to increase the viscosity at 0° C. when the blended amount thereof is smaller, setting the proportion of the chlorinated butyl rubber to the more preferred range (from 20 mass % to 90 mass %) or even more preferred range (from 30 mass % to 70 mass %) described above is effective to set the viscosity (especially, viscosity at 0° C.) to the proper range specified in an embodiment of the present invention.

In the sealant composition of an embodiment of the present invention, not all the butyl rubber is required to be the halogenated butyl rubber (chlorinated butyl rubber), and non-halogenated butyl rubber can also be used in combination. Examples of the non-halogenated butyl rubber include unmodified butyl rubber normally used in a sealant composition, such as BUTYL-065 available from JSR Corporation, and BUTYL-301 available from LANXESS AG. In a case where the halogenated butyl rubber and the non-halogenated butyl rubber are used in combination, a blended amount of the non-halogenated butyl rubber may be preferably less than 20 mass %, and more preferably less than 10 mass % per 100 mass % of the rubber component.

In the sealant composition of an embodiment of the present invention, two or more types of rubber are preferably used in combination as the butyl rubber. That is, other type of halogenated butyl rubber (for example, brominated butyl rubber) or the non-halogenated butyl rubber is preferably used in combination with respect to the chlorinated butyl rubber. The three types of the chlorinated butyl rubber, other type of halogenated butyl rubber (brominated butyl rubber), and the non-halogenated butyl rubber mutually differ in a vulcanization rate, and thus, when at least the two types are used in combination, the physical properties (viscosity, elasticity, and the like) of the sealant composition obtained after vulcanization do not become uniform due to a difference in the vulcanization rate. That is, due to a distribution (variation in concentration) of rubber differing in a vulcanization rate in the sealant composition, a relatively hard portion and a relatively soft portion are mixed in the sealant layer obtained after vulcanization. As a result, this is advantageous in that fluidity is suppressed in the relatively hard portion and sealing properties are exhibited in the relatively soft portion, and thus such performance is provided in a well-balanced, compatible manner.

In the sealant composition of an embodiment of the present invention, other diene rubber than the butyl rubber can also be blended as the rubber component. As other diene rubber, rubber that is generally used in a sealant composition, such as natural rubber (NR), isoprene rubber (IR), butadiene rubber (BR), styrene butadiene rubber (SBR), styrene isoprene butadiene rubber (SIBR), ethylene propylene diene rubber (EPDM), chloroprene rubber (CR), and acrylonitrile butadiene rubber (NBR) can be used. Other diene rubber may be used alone or as a discretionary blend.

The sealant composition according to an embodiment of the present invention preferably contains a crosslinking agent and an organic peroxide. Note that “crosslinking agent” in an embodiment of the present invention refers to a crosslinking agent excluding an organic peroxide, and examples of the crosslinking agent include sulfur, flowers of zinc, cyclic sulfide, a resin (resin vulcanization), and amine (amine vulcanization). Examples of the resin (resin vulcanization) include phenol formaldehyde resins. Examples of the amine (amine vulcanization) include phenylhydroxylamine. As the crosslinking agent, a crosslinking agent including a sulfur component (for example, sulfur) is preferably used. The crosslinking agent and the organic peroxide are used in combination and are blended in this manner, and accordingly, adequate crosslinking for providing ensuring of sealing properties and prevention of a flow of the sealant in a compatible manner can be realized.

A blended amount of the crosslinking agent is preferably from 0.1 parts by mass to 40 parts by mass, more preferably from 0.5 parts by mass to 20 parts by mass, and even more preferably from 1 part by mass to 10 parts by mass, per 100 parts by mass of the rubber component described above. A blended amount of the organic peroxide is preferably from 1 part by mass to 40 parts by mass, more preferably form 5.0 parts by mass to 20 parts by mass, and even more preferably from 5 parts by mass to 15 parts by mass, per 100 parts by mass of the rubber component described above. When the blended amount of the crosslinking agent is less than 0.1 parts by mass, the blended amount of the crosslinking agent is identical to a blended amount in the case of including substantially no crosslinking agent, and appropriate crosslinking cannot be performed. When the blended amount of the crosslinking agent exceeds 40 parts by mass, crosslinking of the sealant composition excessively proceeds, and sealing properties decrease. When the blended amount of the organic peroxide is less than 1 part by mass, the blended amount of the organic peroxide is excessively small, and crosslinking cannot be performed sufficiently, and desired physical properties cannot be obtained. When the blended amount of the organic peroxide exceeds 40 parts by mass, crosslinking of the sealant composition excessively proceeds, and sealing properties decrease.

In particular, in the range described above, because the crosslinking agent tends to increase the tensile stress at 20% elongation at 23° C. when the blended amount thereof is greater and tends to reduce the tensile stress at 20% elongation at 23° C. when the blended amount thereof is smaller, setting the proportion of the crosslinking agent to the more preferred range (from 0.5 parts by mass to 20 parts by mass) or even more preferred range (from 1 part by mass to 10 parts by mass) described above is effective to set the tensile stress at 20% elongation (especially, tensile stress at 20% elongation at 23° C.) to the proper range specified in an embodiment of the present invention. Similarly, in the range described above, because the crosslinking agent tends to increase the viscosity at 0° C. when the blended amount thereof is greater and tends to reduce the viscosity at 0° C. when the blended amount thereof is smaller, setting the blended amount of the crosslinking agent to the more preferred range (from 0.5 parts by mass to 20 parts by mass) or even more preferred range (from 1 part by mass to 10 parts by mass) described above is effective to set the viscosity (especially, viscosity at 0° C.) to the proper range specified in an embodiment of the present invention. Furthermore, in the range described above, because the organic peroxide tends to reduce the viscosity at 23° C. when the blended amount thereof is greater and tends to increase the viscosity at 23° C. when the blended amount thereof is smaller, setting the blended amount of the organic peroxide to the more preferred range (from 1.0 part by mass to 20 parts by mass) or even more preferred range (from 5 parts by mass to 15 parts by mass) described above is effective to set the viscosity (especially, viscosity at 0° C.) to the proper range specified in an embodiment of the present invention.

When the crosslinking agent and the organic peroxide are used in combination in this manner, a mass ratio A/B of a blended amount A of the crosslinking agent to a blended amount B of the organic peroxide may be preferably from 5/1 to 1/200, and more preferably from 1/10 to 1/20. According to such a blending proportion, ensuring of sealing properties and prevention of a flow of the sealant can be provided in a better-balanced, compatible manner.

Examples of the organic peroxide include dicumyl peroxide, t-butyl cumyl peroxide, benzoyl peroxide, dibenzoyl peroxide, butyl hydroperoxide, p-chlorobenzoyl peroxide, and 1,1,3,3-tetramethylbutyl hydroperoxide. Particularly, an organic peroxide having a one-minute half-life temperature of from 100° C. to 200° C. is preferable, and among the specific examples described above, dicumyl peroxide and t-butyl cumyl peroxide are particularly preferable. Note that in an embodiment of the present invention, as “one-minute half-life temperature,” generally, a value described in the “Organic Peroxide Catalog No. 10 Ed.” from Nippon Oil & Fats Co., Ltd. is employed, and in a case where a value is not described, a value determined from thermal decomposition in an organic solvent by a method identical to a method described in the catalog is employed.

In the sealant composition of an embodiment of the present invention, a crosslinking aid is preferably blended. Crosslinking aid refers to a compound that acts as a crosslinking reaction catalyst by blending the compound with the crosslinking agent including the sulfur component. The crosslinking agent and the crosslinking aid are blended, and accordingly, the vulcanization rate can be increased, and the productivity of the sealant composition can be enhanced. A blended amount of the crosslinking aid is preferably more than 0 parts by mass and less than 1 part by mass, and more preferably from 0.1 parts by mass to 0.9 parts by mass per 100 parts by mass of the rubber component described above. The blended amount of the crosslinking aid is reduced in this manner, and accordingly, degradation (heat degradation) of the sealant composition can be suppressed while promoting crosslinking reaction as a catalyst. When the blended amount of the crosslinking aid is 1 part by mass or more, the effect of suppressing heat degradation cannot be obtained sufficiently. Note that crosslinking aid is a crosslinking aid that acts as a crosslinking reaction catalyst by blending the crosslinking aid with the crosslinking agent including the sulfur component as described above, and thus, when the crosslinking aid coexists with an organic peroxide instead of the sulfur component, the effect as a crosslinking reaction catalyst cannot be obtained, and a large content of the crosslinking aid needs to be used, and heat degradation is promoted.

When the crosslinking agent and the crosslinking aid are used in combination, the blended amount of the crosslinking agent is preferably from 50 mass % to 400 mass %, and more preferably from 100 mass % to 200 mass %, of the blended amount of the crosslinking aid described above. By adequately blending the crosslinking agent with the crosslinking aid as described above, a function of the crosslinking aid as a catalyst can be exhibited well, and this is advantageous to provide ensuring of the sealing properties and prevention of a flow of the sealant in a compatible manner. When the blended amount of the crosslinking agent is less than 50 mass % of the blended amount of the crosslinking aid, fluidity decreases. When the blended amount of the crosslinking agent exceeds 400 mass % of the blended amount of the crosslinking aid, deterioration resistance performance decreases.

Examples of the crosslinking aid include sulfenamide-based, thiazole-based, thiuram-based, thiourea-based, guanidine-based, dithiocarbamate-based, aldehyde-amine-based, aldehyde-ammonia-based, imidazoline-based, and xanthogen-based compounds (vulcanization accelerators). Among these, thiazole-based, thiuram-based, guanidine-based, and dithiocarbamate-based vulcanization accelerators can be used suitably. Examples of the thiazole-based vulcanization accelerator include 2-mercaptobenzothiazole, and dibenzothiazyl disulfide. Examples of the thiuram-based vulcanization accelerator include tetramethylthiuram monosulfide, and tetramethylthiuram disulfide. Examples of the guanidine-based vulcanization accelerator include diphenylguanidine, and di-ortho-tolylguanidine. Examples of the dithiocarbamate-based vulcanization accelerator include sodium dimethyldithiocarbamate, and sodium diethyldithiocarbamate. Particularly, in an embodiment of the present invention, thiazole-based or thiuram-based vulcanization accelerators are preferably used, and variation in the performance of the sealant composition obtained can be suppressed.

Note that, for example, a compound such as quinone dioxime that actually functions as the crosslinking agent may be referred to as the crosslinking aid for the sake of convenience, but crosslinking aid in an embodiment of the present invention is a compound functioning as a catalyst of crosslinking reaction using the crosslinking agent as described above, and thus, the quinone dioxime does not correspond to the crosslinking aid in an embodiment of the present invention.

The sealant composition of an embodiment of the present invention is preferably blended with a liquid polymer. The liquid polymer is blended in this manner, and accordingly, the viscosity of the sealant composition can be enhanced, and sealing properties can improve. A blended amount of the liquid polymer is preferably from 50 parts by mass to 400 parts by mass, more preferably from 70 parts by mass to 200 parts by mass, and even more preferably from 80 parts by mass to 200 parts by mass, per 100 parts by mass of the rubber component described above. When the blended amount of the liquid polymer is less than 50 parts by mass, the effect of enhancing the viscosity of the sealant composition cannot be obtained sufficiently. When the blended amount of the liquid polymer exceeds 400 parts by mass, a flow of the sealant cannot be prevented sufficiently.

Note that, in the range described above, because the liquid polymer tends to reduce the tensile stress at 20% elongation at 23° C. when the blended amount thereof is greater and tends to increase the tensile stress at 20% elongation at 23° C. when the blended amount thereof is smaller, setting the blended amount of the liquid polymer to the more preferred range (from 70 parts by mass to 200 parts by mass) or even more preferred range (from 80 parts by mass to 200 parts by mass) described above is effective to set the tensile stress at 20% elongation (especially, tensile stress at 20% elongation at 23° C.) to the proper range specified in an embodiment of the present invention. Similarly, in the range described above, because the liquid polymer tends to reduce the viscosity at 0° C. when the blended amount thereof is greater and tends to increase the viscosity at 0° C. when the blended amount thereof is smaller, setting the blended amount of the liquid polymer to the more preferred range (from 70 parts by mass to 200 parts by mass) or even more preferred range (from 80 parts by mass to 200 parts by mass) described above is effective to set the viscosity (especially, viscosity at 0° C.) to the proper range specified in an embodiment of the present invention.

The liquid polymer is preferably co-crosslinkable with the rubber component (butyl rubber) in the sealant composition, and examples of the liquid polymer include paraffin oil, polybutene oil, polyisoprene oil, polybutadiene oil, polyisobutene oil, aroma oil, and polypropylene glycol. From the perspective of reducing the temperature dependency of the physical properties of the sealant composition and imparting proper physical properties to the sealant regardless of the temperature condition, among these, paraffin oil, polybutene oil, polyisoprene oil, polybutadiene oil, aroma oil, and polypropylene glycol are preferable, and particularly, paraffin oil is preferably used.

Specifically, in the range described above, because the paraffin oil tends to reduce the tensile stress at 20% elongation at 23° C. when the blended amount thereof is greater and tends to increase the tensile stress at 20% elongation at 23° C. when the blended amount thereof is smaller, employing the paraffin oil as the liquid polymer is effective to set the tensile stress at 20% elongation (especially, tensile stress at 20% elongation at 23° C.) to the proper range specified in an embodiment of the present invention. Similarly, in the range described above, because the paraffin oil tends to reduce the viscosity at 0° C. when the blended amount thereof is greater and tends to increase the viscosity at 0° C. when the blended amount thereof is smaller, employing the paraffin oil as the liquid polymer is effective to set the viscosity (especially, viscosity at 0° C.) to the proper range specified in an embodiment of the present invention.

The molecular weight of the liquid polymer is preferably 800 or more, more preferably 1000 or more, and even more preferably 1200 or more and 3000 or less. By using the liquid polymer having a large molecular weight in this manner, transfer of an oil component from the sealant layer provided in the tire inner surface to a tire main body to affect the tire can be prevented.

The sealant composition including the blend described above contains at least the butyl rubber, and accordingly, the sealant composition imparts adequately high viscosity to the rubber component, and at the same time, crosslinking is performed by using a combination of the crosslinking agent and the organic peroxide, and accordingly, adequate elasticity that does not cause a flow during travel is obtained while viscosity sufficient to obtain good sealing properties is ensured, and these performances can be provided in a well-balanced, compatible manner. Furthermore, by the synergistic effects (tendency of the physical properties described above) of the rubber component described above (blended amounts of butyl rubber, halogenated butyl rubber, and chlorinated butyl rubber), blended amounts of the crosslinking agent and the organic peroxide, and the blended amount of the liquid polymer, the tensile stresses at 20% elongation at 23° C. and 80° C., and the viscosities at a low temperature (0° C.), a moderate temperature condition (40° C.), and a high temperature condition (80° C.) can be adjusted to appropriate ranges specified in an embodiment of the present invention. In particular, in a case where a proper amount of the paraffin oil was blended as the liquid polymer, the tensile stresses at 20% elongation at 23° C. and 80° C., and the viscosities at a low temperature (0° C.), a moderate temperature condition (40° C.), and a high temperature condition (80° C.) can be efficiently adjusted to appropriate ranges specified in an embodiment of the present invention. Thus, the sealant composition can be used suitably in the sealant layer 10 (sealant) of the self-sealing type pneumatic tire, and it becomes possible to provide suppression of a flow during travel and good sealing properties in a well-balanced and highly compatible manner. Furthermore, effects of exhibiting good sealing properties in a low temperature environment and suppressing a flow of the sealant during storage can be also expected.

An embodiment of the present invention will further be described below by way of Examples, but the scope of an embodiment of the present invention is not limited to Examples.

### EXAMPLES

Tires of Comparative Examples A1 to A4 and Examples A1 to A37, in which the blend and physical properties of the sealant composition constituting the sealant layer were set to those described in Tables 1 to 3, and tires of Comparative Examples B1 to B4 and Examples B1 to B37, in which the blend and physical properties of the sealant composition constituting the sealant layer were set to those described in Tables 4 to 6, were manufactured. The tires had a tire size of 255/40R20, included the basic structure illustrated in FIG. 1, and included a sealant layer containing a sealant on an inner side in a tire radial direction of an innerliner layer in a tread portion. Note that, Tables 1 to 3 corresponded to the first sealant compositions according to an embodiment of the present invention, and Tables 4 to 6 corresponded to the second sealant composition according to an embodiment of the present invention.

Note that, regarding Tables 1 to 3, “tensile stress at 20% elongation” was measured by preparing a JIS No. 3 dumbbell-shaped test piece using each of the sealant compositions used in the tires in accordance with JIS K 6251 and performing tensile testing at a pulling speed of 500 mm/min at each designated temperature condition (23° C. or 80° C.). Furthermore, regarding Tables 4 to 6, “viscosity” was measured by preparing a sample having a diameter of 25 mm and a thickness of 1.5 mm using each of the sealant compositions used in the tires and by using a rotational rheometer for this sample under conditions of amount of deformation of 0.1% and a frequency of 1 Hz at each designated temperature condition (0° C., 40° C., 80° C.).

Note that, although Example A3 and Comparative Example A2 had the common blend, by changing the mixing procedure, the tensile stresses at 20% elongation were varied. Similarly, although Example B3 and Comparative Example B2 had the common blend, by changing the mixing procedure, the tensile stresses at 20% elongation were varied.

For these test tires, by the following test methods, the sealing properties at room temperature (“sealing properties (room temperature)” in the tables), sealing properties in a low temperature environment (“sealing properties (−20° C.) in the tables), storage performance, and fluidity of the sealant were evaluated. The results are shown in Tables 1 to 6.

Sealing Properties at Room Temperature

The test tires were mounted on wheels having a rim size of 20×9J, and were mounted on a test vehicle, and at an initial air pressure of 250 kPa, a load of 8.5 kN, and a temperature of 23° C. (room temperature), a nail having a diameter of 4.0 mm was inserted into the tread portion, and then an air pressure of each of the tires left to stand for one hour in a state where the nail was removed was measured. The evaluation results are indicated by the following five levels. Note that, when scores of the evaluation results are “2” or more, this means that sufficient sealing properties are exhibited, and that as the scores are larger, better sealing properties are exhibited.

5: Air pressure obtained after the standing is 240 kPa or more and 250 kPa or less

4: Air pressure obtained after the standing is 230 kPa or more and less than 240 kPa

3: Air pressure obtained after the standing is 215 kPa or more and less than 230 kPa

2: Air pressure obtained after the standing is 200 kPa or more and less than 215 kPa

1: Air pressure obtained after the standing is less than 200 kPa

Sealing Properties in Low-Temperature Environments

After the test tires were cooled at a temperature of −20° C. for 24 hours, the test tires were mounted on wheels having a rim size of 20×9J, and were mounted on a test vehicle, and at an initial air pressure of 250 kPa, a load of 8.5 kN, and a temperature of −20° C., a nail having a diameter of 4.0 mm was inserted into the tread portion, and further, an air pressure of each of the test tires left to stand for one hour in a −20° C. environment in a state where the nail was removed was measured. The evaluation results are indicated by the following five levels. Note that, when scores of the evaluation results are “2” or more, this means that sufficient sealing properties are exhibited, and that as the scores are larger, better sealing properties are exhibited.

5: Air pressure obtained after the standing is 240 kPa or more and 250 kPa or less

4: Air pressure obtained after the standing is 230 kPa or more and less than 240 kPa

3: Air pressure obtained after the standing is 215 kPa or more and less than 230 kPa

2: Air pressure obtained after the standing is 200 kPa or more and less than 215 kPa

1: Air pressure obtained after the standing is less than 200 kPa

Storage Performance

The test tire was stored in a thermostatic chamber at 70° C. for 70 days, and the flow state of the sealant after the storage was examined. In the evaluation results, lines of 20×40 squares each having a grid width of 5 mm were ruled in a surface of the sealant layer before the storage, and the number of the squares having a distorted shape after the storage was counted, and then, the case where no flow of the sealant was observed (the number of the distorted squares was 0) was indicated as “Excellent”, the case where the number of the distorted squares was less than ¼ of the total number of the squares was indicated as “Good”, and the case where the number of the distorted squares was 1/4 or more of the total number of the squares was indicated as “Fail”.

Fluidity of Sealant

The test tires were mounted on wheels having a rim size of 20×9J, and mounted on a drum testing machine, and at an air pressure of 220 kPa, a load of 8.5 kN, and a travel speed of 80 km/h, travel for one hour was performed, and a flow state of the sealant after the travel was examined. In the evaluation results, lines of 20×40 squares each having a grid width of 5 mm were ruled in a surface of the sealant layer before the travel, and the number of the squares having a distorted shape after the travel was counted, and then, the case where no flow of the sealant was observed (the number of the distorted squares was 0) was indicated as “Excellent”, the case where the number of the distorted squares was less than ¼ of the total number of the squares was indicated as “Good”, and the case where the number of the distorted squares was 1/4 or more of the total number of the squares was indicated as “Fail”.

TABLE 1

| | | | | | | | | | | Comparative |
|---|---|---|---|---|---|---|---|---|---|---|
| | | | Example | Example | Example | Example | Example | Example | Example | Example |
| | | | A1 | A2 | A3 | A4 | A5 | A6 | A7 | A1 |
| Blend | Butyl rubber 1 | Parts by mass | 80 | 40 | 10 | | 80 | 80 | 80 | 80 |
| | Butyl rubber 2 | Parts by mass | 10 | 50 | | 10 | 10 | 10 | 10 | 10 |
| | Natural rubber | Parts by mass | 10 | 10 | 90 | 90 | 10 | 10 | 10 | 10 |
| | Organic peroxide | Parts by mass | 10 | 10 | 10 | 10 | 10 | 10 | 10 | 10 |
| | Crosslinking agent 1 | Parts by mass | 1 | 1 | 1 | 1 | | | 1 | |
| | Crosslinking agent 2 | Parts by mass | | | | | 1 | | | |
| | Crosslinking agent 3 | Parts by mass | | | | | | 1 | | 1 |
| | Crosslinking aid 1 | Parts by mass | 0.5 | 0.5 | 0.5 | 0.5 | | | | 0.5 |
| | Crosslinking aid 2 | Parts by mass | | | | | | | | |
| | Liquid polymer 1 | Parts by mass | 200 | 200 | 200 | 200 | 200 | 200 | 200 | 200 |
| | Liquid polymer 2 | Parts by mass | | | | | | | | |
| | Liquid polymer 3 | Parts by mass | | | | | | | | |
| Physical | Stress (23° C.) M₂₃ | MPa | 0.02 | 0.03 | 0.02 | 0.03 | 0.01 | 0.02 | 0.01 | 0.05 |
| properties | Stress (80° C.) M₈₀ | MPa | 0.004 | 0.004 | 0.002 | 0.002 | 0.005 | 0.008 | 0.004 | 0.004 |

| | | | | | | | | | |
|---|---|---|---|---|---|---|---|---|---|
| | Ratio M₂₃/M₈₀ | 5.0 | 7.5 | 10.0 | 15.0 | 2.0 | 2.5 | 2.5 | 12.5 |
| Evaluation | Sealing properties (room | 5 | 5 | 5 | 5 | 5 | 3 | 3 | 1 |
| results | temperature) | | | | | | | | |
| | Sealing properties (−20° C.) | 5 | 5 | 3 | 3 | 4 | 3 | 3 | 1 |
| | Storage performance | Excellent | Excellent | Excellent | Excellent | Good | Good | Excellent | Excellent |
| | Fluidity | Excellent | Excellent | Good | Good | Excellent | Excellent | Good | Excellent |

| | | | Comparative | Comparative | | | | |
|---|---|---|---|---|---|---|---|---|
| | | | Example | Example | Example | Example | Example | Example |
| | | | A2 | A3 | A8 | A9 | A10 | A11 |
| Blend | Butyl rubber 1 | Parts by mass | 10 | | 80 | 80 | 80 | 80 |
| | Butyl rubber 2 | Parts by mass | | | 10 | 10 | 10 | 10 |
| | Natural rubber | Parts by mass | 90 | 100 | 10 | 10 | 10 | 10 |
| | Organic peroxide | Parts by mass | 10 | 10 | 10 | 10 | 10 | 10 |
| | Crosslinking agent 1 | Parts by mass | 1 | 1 | 1 | 1 | 1 | 1 |
| | Crosslinking agent 2 | Parts by mass | | | | | | |
| | Crosslinking agent 3 | Parts by mass | | | | | | |
| | Crosslinking aid 1 | Parts by mass | 0.5 | 0.5 | 0.5 | 0.5 | 0.5 | 0.5 |
| | Crosslinking aid 2 | Parts by mass | | | | | | |
| | Liquid polymer 1 | Parts by mass | 200 | 200 | 40 | 50 | 400 | 450 |
| | Liquid polymer 2 | Parts by mass | | | | | | |
| | Liquid polymer 3 | Parts by mass | | | | | | |
| Physical | Stress (23° C.) M₂₃ | MPa | 0.02 | 0.05 | 0.03 | 0.028 | 0.008 | 0.006 |
| properties | Stress (80° C.) M₈₀ | MPa | 0.001 | 0.003 | 0.008 | 0.007 | 0.002 | 0.002 |

| | | | | | | | |
|---|---|---|---|---|---|---|---|
| | Ratio M₂₃/M₈₀ | 20.0 | 16.7 | 3.8 | 4.0 | 3.6 | 3.0 |
| Evaluation | Sealing properties (room | 5 | 3 | 3 | 3 | 5 | 5 |
| results | temperature) | | | | | | |
| | Sealing properties (−20° C.) | 5 | 3 | 3 | 3 | 5 | 5 |
| | Storage performance | Good | Fail | Excellent | Excellent | Good | Good |
| | Fluidity | Fail | Excellent | Excellent | Excellent | Good | Good |

TABLE 2

| | | | | Comparative | | | | | |
|---|---|---|---|---|---|---|---|---|---|
| | | | Example | Example | Example | Example | Example | Example | Example |
| | | | A12 | A4 | A13 | A14 | A15 | A16 | A17 |
| Blend | Butyl rubber 1 | Parts by mass | 80 | 80 | 80 | 80 | 80 | 80 | 80 |
| | Butyl rubber 2 | Parts by mass | 10 | 10 | 10 | 10 | 10 | 10 | 10 |
| | Natural rubber | Parts by mass | 10 | 10 | 10 | 10 | 10 | 10 | 10 |
| | Organic peroxide | Parts by mass | 0.5 | 0.5 | 1 | 40 | 45 | 10 | 10 |
| | Crosslinking agent 1 | Parts by mass | 1 | 1 | 1 | 1 | 1 | 0.1 | 40 |
| | Crosslinking agent 2 | Parts by mass | | | | | | | |
| | Crosslinking agent 3 | Parts by mass | | | | | | | |
| | Crosslinking aid 1 | Parts by mass | 0.5 | 0.5 | 0.5 | 0.5 | 0.5 | 0.5 | 0.5 |
| | Crosslinking aid 2 | Parts by mass | | | | | | | |
| | Liquid polymer 1 | Parts by mass | 200 | | 200 | 200 | 200 | 200 | 200 |
| | Liquid polymer 2 | Parts by mass | | | | | | | |
| | Liquid polymer 3 | Parts by mass | | 200 | | | | | |
| Physical | Stress (23° C.) M₂₃ | MPa | 0.02 | 0.01 | 0.02 | 0.01 | 0.008 | 0.03 | 0.008 |
| properties | Stress (80° C.) M₈₀ | MPa | 0.008 | 0.001 | 0.007 | 0.003 | 0.005 | 0.004 | 0.002 |

| | | | | | | | | |
|---|---|---|---|---|---|---|---|---|
| | Ratio M₂₃/M₈₀ | 2.5 | 10.0 | 2.9 | 4.0 | 1.6 | 7.5 | 4.0 |
| Evaluation | Sealing properties (room | 3 | 5 | 3 | 5 | 5 | 3 | 5 |
| results | temperature) | | | | | | | |
| | Sealing properties (−20° C.) | 3 | 5 | 4 | 5 | 5 | 5 | 3 |
| | Storage performance | Excellent | Excellent | Excellent | Excellent | Good | Excellent | Excellent |
| | Fluidity | Excellent | Fail | Excellent | Good | Good | Excellent | Good |

| | | | Example | Example | Example | Example | Example | Example |
|---|---|---|---|---|---|---|---|---|
| | | | A18 | A19 | A20 | A21 | A22 | A23 |
| Blend | Butyl rubber 1 | Parts by mass | 80 | 80 | 80 | 80 | 80 | 10 |
| | Butyl rubber 2 | Parts by mass | 10 | 10 | 10 | 10 | 10 | 10 |
| | Natural rubber | Parts by mass | 10 | 10 | 10 | 10 | 10 | 80 |
| | Organic peroxide | Parts by mass | 10 | 10 | 10 | 10 | 10 | 10 |
| | Crosslinking agent 1 | Parts by mass | 1 | 1 | 1 | 1 | 1 | 1 |
| | Crosslinking agent 2 | Parts by mass | | | | | | |
| | Crosslinking agent 3 | Parts by mass | | | | | | |
| | Crosslinking aid 1 | Parts by mass | 1 | 0.5 | 0.5 | | | 0.5 |
| | Crosslinking aid 2 | Parts by mass | | | | 0.5 | 0.5 | |
| | Liquid polymer 1 | Parts by mass | 200 | | | 200 | | 200 |
| | Liquid polymer 2 | Parts by mass | | 200 | | | | |
| | Liquid polymer 3 | Parts by mass | | | 200 | | | |
| Physical | Stress (23° C.) M₂₃ | MPa | 0.03 | 0.02 | 0.01 | 0.03 | 0.03 | 0.03 |
| properties | Stress (80° C.) M₈₀ | MPa | 0.005 | 0.007 | 0.003 | 0.010 | 0.002 | 0.005 |

| | | | | | | | |
|---|---|---|---|---|---|---|---|
| | Ratio M₂₃/M₈₀ | 6.0 | 2.9 | 4.0 | 3.0 | 15.0 | 6.0 |
| Evaluation | Sealing properties (room | 3 | 3 | 5 | 3 | 3 | 3 |
| results | temperature) | | | | | | |
| | Sealing properties (−20° C.) | 4 | 4 | 5 | 3 | 3 | 3 |
| | Storage performance | Excellent | Good | Good | Excellent | Excellent | Excellent |
| | Fluidity | Excellent | Excellent | Good | Excellent | Excellent | Excellent |

TABLE 3

| | | | Example | Example | Example | Example | Example | Example | Example | Example |
|---|---|---|---|---|---|---|---|---|---|---|
| | | | A24 | A25 | A26 | A27 | A28 | A29 | A30 | A31 |
| Blend | Butyl rubber 1 | Parts by mass | 20 | 30 | 70 | 85 | 80 | 80 | 80 | 80 |
| | Butyl rubber 2 | Parts by mass | 10 | 10 | 10 | 5 | 10 | 10 | 10 | 10 |
| | Natural rubber | Parts by mass | 70 | 60 | 20 | 10 | 10 | 10 | 10 | 10 |
| | Organic peroxide | Parts by mass | 10 | 10 | 10 | 10 | 10 | 10 | 10 | 10 |
| | Crosslinking agent 1 | Parts by mass | 1 | 1 | 1 | 1 | 0.5 | 1 | 10 | 20 |
| | Crosslinking agent 2 | Parts by mass | | | | | | | | |
| | Crosslinking agent 3 | Parts by mass | | | | | | | | |
| | Crosslinking aid 1 | Parts by mass | 0.5 | 0.5 | 0.5 | 0.5 | 0.5 | 0.5 | 0.5 | 0.5 |
| | Crosslinking aid 2 | Parts by mass | | | | | | | | |
| | Liquid polymer 1 | Parts by mass | 200 | 200 | 200 | 200 | 200 | 200 | 200 | 200 |
| | Liquid polymer 2 | Parts by mass | | | | | | | | |
| | Liquid polymer 3 | Parts by mass | | | | | | | | |
| Physical | Stress (23° C.) M₂₃ | MPa | 0.03 | 0.03 | 0.02 | 0.02 | 0.02 | 0.02 | 0.030 | 0.03 |
| properties | Stress (80° C.) M₈₀ | MPa | 0.005 | 0.005 | 0.004 | 0.004 | 0.004 | 0.005 | 0.006 | 0.008 |

| | | | | | | | | | |
|---|---|---|---|---|---|---|---|---|---|
| | Ratio M₂₃/M₈₀ | 6.0 | 6.0 | 5.0 | 5.0 | 5.0 | 4.0 | 5.0 | 3.8 |
| Evaluation | Sealing properties (room | 3 | 3 | 4 | 4 | 5 | 5 | 4 | 4 |
| results | temperature) | | | | | | | | |
| | Sealing properties (−20° C.) | 3 | 3 | 3 | 4 | 5 | 4 | 4 | 3 |
| | Storage performance | Excellent | Excellent | Excellent | Excellent | Excellent | Excellent | Excellent | Excellent |
| | Fluidity | Excellent | Excellent | Excellent | Excellent | Excellent | Excellent | Excellent | Excellent |

| | | | Example | Example | Example | Example | Example | Example |
|---|---|---|---|---|---|---|---|---|
| | | | A32 | A33 | A34 | A35 | A36 | A37 |
| Blend | Butyl rubber 1 | Parts by mass | 80 | 80 | 80 | 80 | 80 | 80 |
| | Butyl rubber 2 | Parts by mass | 10 | 10 | 10 | 10 | 10 | 10 |
| | Natural rubber | Parts by mass | 10 | 10 | 10 | 10 | 10 | 10 |
| | Organic peroxide | Parts by mass | 5 | 15 | 20 | 10 | 10 | 10 |
| | Crosslinking agent 1 | Parts by mass | 1 | 1 | 1 | 1 | 1 | 1 |
| | Crosslinking agent 2 | Parts by mass | | | | | | |
| | Crosslinking agent 3 | Parts by mass | | | | | | |
| | Crosslinking aid 1 | Parts by mass | 0.5 | 0.5 | 0.5 | 0.5 | 0.5 | 0.5 |
| | Crosslinking aid 2 | Parts by mass | | | | | | |
| | Liquid polymer 1 | Parts by mass | 200 | 200 | 200 | 70 | 80 | 180 |
| | Liquid polymer 2 | Parts by mass | | | | | | |
| | Liquid polymer 3 | Parts by mass | | | | | | |
| Physical | Stress (23° C.) M₂₃ | MPa | 0.02 | 0.02 | 0.01 | 0.02 | 0.02 | 0.01 |
| properties | Stress (80° C.) M₈₀ | MPa | 0.004 | 0.003 | 0.003 | 0.003 | 0.003 | 0.002 |

| | | | | | | | |
|---|---|---|---|---|---|---|---|
| | Ratio M₂₃/M₈₀ | 5.0 | 6.7 | 3.3 | 6.7 | 6.7 | 5.0 |
| Evaluation | Sealing properties (room | 4 | 5 | 5 | 4 | 5 | 5 |
| results | temperature) | | | | | | |
| | Sealing properties (−20° C.) | 4 | 4 | 5 | 4 | 4 | 5 |
| | Storage performance | Excellent | Excellent | Good | Excellent | Excellent | Good |
| | Fluidity | Excellent | Good | Good | Excellent | Good | Good |

TABLE 4

| | | | | | | | | | | Comparative |
|---|---|---|---|---|---|---|---|---|---|---|
| | | | Example | Example | Example | Example | Example | Example | Example | Example |
| | | | B1 | B2 | B3 | B4 | B5 | B6 | B7 | B1 |
| Blend | Butyl rubber 1 | Parts by mass | 80 | 40 | 10 | | 80 | 80 | 80 | 80 |
| | Butyl rubber 2 | Parts by mass | 10 | 50 | | 10 | 10 | 10 | 10 | 10 |
| | Natural rubber | Parts by mass | 10 | 10 | 90 | 90 | 10 | 10 | 10 | 10 |
| | Organic peroxide | Parts by mass | 10 | 10 | 10 | 10 | 10 | 10 | 10 | 10 |
| | Crosslinking agent 1 | Parts by mass | 1 | 1 | 1 | 1 | | | 1 | |
| | Crosslinking agent 2 | Parts by mass | | | | | 1 | | | |
| | Crosslinking agent 3 | Parts by mass | | | | | | 1 | | 1 |
| | Crosslinking aid 1 | Parts by mass | 0.5 | 0.5 | 0.5 | 0.5 | | | | 0.5 |
| | Crosslinking aid 2 | Parts by mass | | | | | | | | |
| | Liquid polymer 1 | Parts by mass | 200 | 200 | 200 | 200 | 200 | 200 | 200 | 200 |
| | Liquid polymer 2 | Parts by mass | | | | | | | | |
| | Liquid polymer 3 | Parts by mass | | | | | | | | |
| Physical | Viscosity (0° C.) V₀ | MPa | 8.0 | 10.0 | 15.0 | 15.0 | 14.0 | 15.0 | 15.0 | 16.0 |
| properties | Viscosity (40° C.) V₄₀ | MPa | 4.0 | 4.0 | 7.0 | 14.0 | 13.0 | 3.0 | 3.0 | 8.0 |
| | Viscosity (80° C.) V₈₀ | MPa | 2.0 | 2.0 | 4.0 | 7.0 | 12.0 | 2.0 | 1.0 | 5.0 |

| | | | | | | | | | |
|---|---|---|---|---|---|---|---|---|---|
| | Ratio V₀/V₄₀ | 2.0 | 2.5 | 2.1 | 1.1 | 1.1 | 5.0 | 5.0 | 2.0 |
| | Ratio V₀/V₈₀ | 4.0 | 5.0 | 3.8 | 2.1 | 1.2 | 7.5 | 15.0 | 3.2 |
| Evaluation | Sealing properties (room | 5 | 5 | 5 | 5 | 5 | 4 | 4 | 1 |
| results | temperature) | | | | | | | | |
| | Sealing properties (−20° C.) | 5 | 5 | 3 | 3 | 4 | 3 | 3 | 1 |
| | Storage performance | Excellent | Excellent | Excellent | Excellent | Good | Good | Excellent | Excellent |
| | Fluidity | Excellent | Excellent | Good | Good | Excellent | Excellent | Good | Excellent |

| | | | Comparative | Comparative | | | | |
|---|---|---|---|---|---|---|---|---|
| | | | Example | Example | Example | Example | Example | Example |
| | | | B2 | B3 | B8 | B9 | B10 | B11 |
| Blend | Butyl rubber 1 | Parts by mass | 10 | | 80 | 80 | 80 | 80 |
| | Butyl rubber 2 | Parts by mass | | | 10 | 10 | 10 | 10 |
| | Natural rubber | Parts by mass | 90 | 100 | 10 | 10 | 10 | 10 |
| | Organic peroxide | Parts by mass | 10 | 10 | 10 | 10 | 10 | 10 |
| | Crosslinking agent 1 | Parts by mass | 1 | 1 | 1 | 1 | 1 | 1 |
| | Crosslinking agent 2 | Parts by mass | | | | | | |
| | Crosslinking agent 3 | Parts by mass | | | | | | |
| | Crosslinking aid 1 | Parts by mass | 0.5 | 0.5 | 0.5 | 0.5 | 0.5 | 0.5 |
| | Crosslinking aid 2 | Parts by mass | | | | | | |
| | Liquid polymer 1 | Parts by mass | 200 | 200 | 40 | 50 | 400 | 450 |
| | Liquid polymer 2 | Parts by mass | | | | | | |
| | Liquid polymer 3 | Parts by mass | | | | | | |
| Physical | Viscosity (0° C.) V₀ | MPa | 18.0 | 15.0 | 14.8 | 14.0 | 3.0 | 2.0 |
| properties | Viscosity (40° C.) V₄₀ | MPa | 14.0 | 14.5 | 13.1 | 12.8 | 2.6 | 1.2 |
| | Viscosity (80° C.) V₈₀ | MPa | 10.0 | 7.0 | 10.8 | 10.1 | 0.8 | 0.6 |

| | | | | | | | |
|---|---|---|---|---|---|---|---|
| | Ratio V₀/V₄₀ | 1.3 | 1.0 | 1.1 | 1.1 | 1.2 | 1.7 |
| | Ratio V₀/V₈₀ | 1.8 | 2.1 | 1.4 | 1.4 | 3.8 | 3.3 |
| Evaluation | Sealing properties (room | 5 | 3 | 3 | 3 | 5 | 5 |
| results | temperature) | | | | | | |
| | Sealing properties (−20° C.) | 5 | 3 | 3 | 3 | 5 | 5 |
| | Storage performance | Good | Fail | Excellent | Excellent | Good | Good |
| | Fluidity | Fail | Excellent | Excellent | Excellent | Good | Good |

TABLE 5

| | | | | Comparative | | | | | |
|---|---|---|---|---|---|---|---|---|---|
| | | | Example | Example | Example | Example | Example | Example | Example |
| | | | B12 | B4 | B13 | B14 | B15 | B16 | B17 |
| Blend | Butyl rubber 1 | Parts by mass | 80 | 80 | 80 | 80 | 80 | 80 | 80 |
| | Butyl rubber 2 | Parts by mass | 10 | 10 | 10 | 10 | 10 | 10 | 10 |
| | Natural rubber | Parts by mass | 10 | 10 | 10 | 10 | 10 | 10 | 10 |
| | Organic peroxide | Parts by mass | 0.5 | 0.5 | 1 | 40 | 45 | 10 | 10 |
| | Crosslinking agent 1 | Parts by mass | 1 | 1 | 1 | 1 | 1 | 0.1 | 40 |
| | Crosslinking agent 2 | Parts by mass | | | | | | | |
| | Crosslinking agent 3 | Parts by mass | | | | | | | |
| | Crosslinking aid 1 | Parts by mass | 0.5 | 0.5 | 0.5 | 0.5 | 0.5 | 0.5 | 0.5 |
| | Crosslinking aid 2 | Parts by mass | | | | | | | |
| | Liquid polymer 1 | Parts by mass | 200 | | 200 | 200 | 200 | 200 | 200 |
| | Liquid polymer 2 | Parts by mass | | | | | | | |
| | Liquid polymer 3 | Parts by mass | | 200 | | | | | |
| Physical | Viscosity (0° C.) V₀ | MPa | 14.8 | 4.0 | 14.0 | 8.0 | 6.0 | 8.0 | 15.0 |
| properties | Viscosity (40° C.) V₄₀ | MPa | 12.6 | 2.5 | 7.0 | 4.0 | 3.0 | 4.0 | 12.0 |
| | Viscosity (80° C.) V₈₀ | MPa | 10.8 | 0.3 | 2.0 | 2.0 | 1.0 | 2.0 | 10.0 |

| | | | | | | | | |
|---|---|---|---|---|---|---|---|---|
| | Ratio V₀/V₄₀ | 1.2 | 1.6 | 2.0 | 2.0 | 2.0 | 2.0 | 1.3 |
| | Ratio V₀/V₈₀ | 1.4 | 13.3 | 7.0 | 4.0 | 6.0 | 4.0 | 1.5 |
| Evaluation | Sealing properties (room | 3 | 5 | 3 | 5 | 5 | 3 | 5 |
| results | temperature) | | | | | | | |
| | Sealing properties (−20° C.) | 3 | 5 | 4 | 5 | 5 | 5 | 3 |
| | Storage performance | Excellent | Excellent | Excellent | Excellent | Good | Excellent | Excellent |
| | Fluidity | Excellent | Fail | Excellent | Good | Good | Excellent | Good |

| | | | Example | Example | Example | Example | Example | Example |
|---|---|---|---|---|---|---|---|---|
| | | | B18 | B19 | B20 | B21 | B22 | A23 |
| Blend | Butyl rubber 1 | Parts by mass | 80 | 80 | 80 | 80 | 80 | 10 |
| | Butyl rubber 2 | Parts by mass | 10 | 10 | 10 | 10 | 10 | 10 |
| | Natural rubber | Parts by mass | 10 | 10 | 10 | 10 | 10 | 80 |
| | Organic peroxide | Parts by mass | 10 | 10 | 10 | 10 | 10 | 10 |
| | Crosslinking agent 1 | Parts by mass | 1 | 1 | 1 | 1 | 1 | 1 |
| | Crosslinking agent 2 | Parts by mass | | | | | | |
| | Crosslinking agent 3 | Parts by mass | | | | | | |
| | Crosslinking aid 1 | Parts by mass | 1 | 0.5 | 0.5 | | | 0.5 |
| | Crosslinking aid 2 | Parts by mass | | | | 0.5 | 0.5 | |
| | Liquid polymer 1 | Parts by mass | 200 | | | 200 | | 200 |
| | Liquid polymer 2 | Parts by mass | | 200 | | | | |
| | Liquid polymer 3 | Parts by mass | | | 200 | | | |
| Physical | Viscosity (0° C.) V₀ | MPa | 10.0 | 9.0 | 7.8 | 8.0 | 13.0 | 14.8 |
| properties | Viscosity (40° C.) V₄₀ | MPa | 8.0 | 3.0 | 3.9 | 4.0 | 8.0 | 12.6 |
| | Viscosity (80° C.) V₈₀ | MPa | 6.0 | 1.0 | 1.9 | 2.0 | 6.0 | 10.8 |

| | | | | | | | |
|---|---|---|---|---|---|---|---|
| | Ratio V₀/V₄₀ | 1.3 | 3.0 | 2.0 | 2.0 | 1.6 | 1.2 |
| | Ratio V₀/V₈₀ | 1.7 | 9.0 | 4.1 | 4.0 | 2.2 | 1.4 |
| Evaluation | Sealing properties (room | 3 | 3 | 5 | 3 | 4 | 3 |
| results | temperature) | | | | | | |
| | Sealing properties (−20° C.) | 4 | 4 | 5 | 5 | 4 | 3 |
| | Storage performance | Excellent | Good | Excellent | Excellent | Excellent | Excellent |
| | Fluidity | Excellent | Excellent | Good | Excellent | Excellent | Excellent |

TABLE 6

| | | | Example | Example | Example | Example | Example | Example | Example | Example |
|---|---|---|---|---|---|---|---|---|---|---|
| | | | B24 | B25 | B26 | B27 | B28 | B29 | B30 | B31 |
| Blend | Butyl rubber 1 | Parts by mass | 20 | 30 | 70 | 85 | 80 | 80 | 80 | 80 |
| | Butyl rubber 2 | Parts by mass | 10 | 10 | 10 | 5 | 10 | 10 | 10 | 10 |
| | Natural rubber | Parts by mass | 70 | 60 | 20 | 10 | 10 | 10 | 10 | 10 |
| | Organic peroxide | Parts by mass | 10 | 10 | 10 | 10 | 10 | 10 | 10 | 10 |
| | Crosslinking agent 1 | Parts by mass | 1 | 1 | 1 | 1 | 0.5 | 1 | 10 | 20 |
| | Crosslinking agent 2 | Parts by mass | | | | | | | | |
| | Crosslinking agent 3 | Parts by mass | | | | | | | | |
| | Crosslinking aid 1 | Parts by mass | 0.5 | 0.5 | 0.5 | 0.5 | 0.5 | 0.5 | 0.5 | 0.5 |
| | Crosslinking aid 2 | Parts by mass | | | | | | | | |
| | Liquid polymer 1 | Parts by mass | 200 | 200 | 200 | 200 | 200 | 200 | 200 | 200 |
| | Liquid polymer 2 | Parts by mass | | | | | | | | |
| | Liquid polymer 3 | Parts by mass | | | | | | | | |
| Physical | Viscosity (0° C.) V₀ | MPa | 14.8 | 13.2 | 8.0 | 7.4 | 15.0 | 14.8 | 10.0 | 9.0 |
| properties | Viscosity (40° C.) V₄₀ | MPa | 12.6 | 10.8 | 4.0 | 3.6 | 12.0 | 12.6 | 8.0 | 3.0 |
| | Viscosity (80° C.) V₈₀ | MPa | 10.8 | 9.2 | 1.8 | 1.5 | 10.0 | 10.8 | 6.0 | 1.0 |

| | | | | | | | | | |
|---|---|---|---|---|---|---|---|---|---|
| | Ratio V₀/V₄₀ | 1.2 | 1.2 | 2.0 | 2.1 | 1.3 | 1.2 | 1.3 | 3.0 |
| | Ratio V₀/V₈₀ | 1.4 | 1.4 | 4.4 | 4.9 | 1.5 | 1.4 | 1.7 | 9.0 |
| Evaluation | Sealing properties (room | 3 | 3 | 4 | 4 | 5 | 5 | 4 | 4 |
| results | temperature) | | | | | | | | |
| | Sealing properties (−20° C.) | 3 | 3 | 3 | 4 | 5 | 4 | 4 | 3 |
| | Storage performance | Excellent | Excellent | Excellent | Excellent | Excellent | Excellent | Excellent | Excellent |
| | Fluidity | Excellent | Excellent | Excellent | Excellent | Excellent | Excellent | Excellent | Excellent |

| | | | Example | Example | Example | Example | Example | Example |
|---|---|---|---|---|---|---|---|---|
| | | | B32 | B33 | B34 | B35 | B36 | B37 |
| Blend | Butyl rubber 1 | Parts by mass | 80 | 80 | 80 | 80 | 80 | 80 |
| | Butyl rubber 2 | Parts by mass | 10 | 10 | 10 | 10 | 10 | 10 |
| | Natural rubber | Parts by mass | 10 | 10 | 10 | 10 | 10 | 10 |
| | Organic peroxide | Parts by mass | 5 | 15 | 20 | 10 | 10 | 10 |
| | Crosslinking agent 1 | Parts by mass | 1 | 1 | 1 | 1 | 1 | 1 |
| | Crosslinking agent 2 | Parts by mass | | | | | | |
| | Crosslinking agent 3 | Parts by mass | | | | | | |
| | Crosslinking aid 1 | Parts by mass | 0.5 | 0.5 | 0.5 | 0.5 | 0.5 | 0.5 |
| | Crosslinking aid 2 | Parts by mass | | | | | | |
| | Liquid polymer 1 | Parts by mass | 200 | 200 | 200 | 70 | 80 | 180 |
| | Liquid polymer 2 | Parts by mass | | | | | | |
| | Liquid polymer 3 | Parts by mass | | | | | | |
| Physical | Viscosity (0° C.) V₀ | MPa | 14.8 | 11.6 | 9.0 | 11.6 | 10.3 | 9.6 |
| properties | Viscosity (40° C.) V₄₀ | MPa | 12.6 | 8.8 | 3.0 | 8.8 | 7.6 | 6.4 |
| | Viscosity (80° C.) V₈₀ | MPa | 10.8 | 6.1 | 1.0 | 6.1 | 5.2 | 4.8 |

| | | | | | | | |
|---|---|---|---|---|---|---|---|
| | Ratio V₀/V₄₀ | 1.2 | 1.3 | 3.0 | 1.3 | 1.4 | 1.5 |
| | Ratio V₀/V₈₀ | 1.4 | 1.9 | 9.0 | 1.9 | 2.0 | 2.0 |
| Evaluation | Sealing properties (room | 4 | 5 | 5 | 4 | 5 | 5 |
| results | temperature) | | | | | | |
| | Sealing properties (−20° C.) | 4 | 4 | 5 | 4 | 4 | 5 |
| | Storage performance | Excellent | Excellent | Good | Excellent | Excellent | Good |
| | Fluidity | Excellent | Good | Good | Excellent | Good | Good |

Types of raw materials used as indicated in Tables 1 to 6 are described below.
Butyl rubber 1: Chlorinated butyl rubber, CHLOROBUTYL1066, available from JSR Corporation
Butyl rubber 2: Brominated butyl rubber, BROMOBUTYL2222, available from JSR Corporation
Natural rubber: Natural rubber available from SRI TRANG
Organic peroxide: Dibenzoyl peroxide, NYPER NS, available from NOF Corp. (1-minute half-life temperature: 133° C.)
Crosslinking agent 1: Sulfur, small lumps of sulfur, available from Hosoi Chemical Industry Co., Ltd.
Crosslinking agent 2: Cyclic sulfide, VALNOC R, available from Ouchi Shinko Chemical Industrial Co., Ltd.
Crosslinking agent 3: Quinone dioxime, VALNOC GM, available from Ouchi Shinko Chemical Industrial Co., Ltd.
Crosslinking aid 1: Thiazole-based vulcanization accelerator, NOCCELER MZ, available from Ouchi Shinko Chemical Industrial Co., Ltd.
Crosslinking aid 2: Thiuram-based vulcanization accelerator, NOCCELER DM-PO available from Ouchi Shinko Chemical Industrial Co., Ltd.
Liquid polymer 1: Paraffin oil, HICALL K-350, available from Kaneda Co. Ltd. (molecular weight: 850)
Liquid polymer 2: Paraffin oil, Diana Process PW-380, available from Idemitsu Kosan Co., Ltd. (molecular weight: 1400)
Liquid polymer 3: Polybutene oil, Nisseki Polybutene HV-15, available from JXTG Nippon Oil & Energy Corporation (molecular weight: 1300)

As can be seen from Tables 1 to 3, pneumatic tires of Examples A1 to A37 exhibited good sealing properties and fluidity at room temperature, and these were provided in a well-balanced, compatible manner. Furthermore, by satisfying the preferred physical properties and blend described above, not only providing the sealing properties at room temperature and the fluidity in a compatible manner, but also additional effects of enhancing the sealing properties in low temperature environments and the storage performance were also achieved. On the other hand, in Comparative Example A1, the sealing properties were degraded because the tensile stress M₂₃ at 20% elongation at 23° C. was too large. In Comparative Example A2, the fluidity of the sealant was degraded because the tensile stress M₈₀ at 20% elongation at 80° C. was too small. In Comparative Example A3, the adequate sealing properties were not achieved and the storage performance was also degraded because the tensile stress M₂₃ at 20% elongation at 23° C. was too large. In Comparative Example A4, the fluidity of the sealant was degraded because the tensile stress M₈₀ at 20% elongation at 80° C. was too small.

As can be seen from Tables 4 to 6, pneumatic tires of Examples B1 to B37 exhibited good sealing properties at room temperature and fluidity, and these were provided in a well-balanced, compatible manner. Furthermore, in addition to providing the sealing properties at room temperature and the fluidity in a compatible manner, additional effects of enhancing the sealing properties in low temperature environments and the storage performance were also achieved. On the other hand, in Comparative Example B1, the sealing properties were degraded because the viscosity V₀ at 0° C. was too large. In Comparative Example B2, the fluidity of the sealant was degraded because the viscosity V₀ at 0° C. was too large. In Comparative Example B3, the adequate sealing properties were not achieved and the storage performance was also degraded because the viscosity V₄₀ at 40° C. was too large. In Comparative Example A4, the fluidity of the sealant was degraded because the viscosity V₈₀ at 80° C. was too small.

### REFERENCE SIGNS LIST

1 Tread portion
2 Sidewall portion
3 Bead portion
4 Carcass layer
5 Bead core
6 Bead filler
7 Belt layer
8 Belt reinforcing layer
9 Innerliner layer
10 Sealant layer
CL Tire equator

1. A sealant composition constituting a sealant layer disposed on an inner surface of a pneumatic tire, the sealant composition demonstrating a tensile stress M₂₃ at 20% elongation at 23° C. of 0.03 MPa or less, and a tensile stress M_{go} at 20% elongation at 80° C. of 0.002 MPa or more.

2. The sealant composition according to claim 1, wherein M₂₃/M₈₀, a ratio of the tensile stress M₂₃ at 20% elongation at 23° C. to the tensile stress M₈₀ at 20% elongation at 80° C., is 2.0 or less.

3. A sealant composition demonstrating a viscosity V₀ at 0° C. of from 2 kPa s to 15 kPa s, a viscosity V₄₀ at 40° C. of from 1 kPa s to 14 kPa s, and a viscosity V₈₀ at 80° C. of from 0.5 kPa s to 12 kPa s.

4. The sealant composition according to claim 3, having V₀/V₄₀, a ratio of the viscosity V₀ at 0° C. to the viscosity V₄₀ at 40° C., of 5 or less.

5. The sealant composition according to claim 3, having V₀/V₈₀, a ratio of the viscosity V₀ at 0° C. to the viscosity V₈₀ at 80° C., of 10 or less.

6. The sealant composition according to claim 1, wherein from 50 parts by mass to 400 parts by mass of a paraffin oil is blended per 100 parts by mass of a rubber component.

7. The sealant composition according to claim 6, wherein a molecular weight of the paraffin oil is 800 or more.

8. The sealant composition according to claim 1, wherein from 1 part by mass to 40 parts by mass of an organic peroxide, from 0.1 parts by mass to 40 parts by mass of a crosslinking agent, and more than 0 parts by mass and less than 1 part by mass of a crosslinking aid are blended per 100 parts by mass of a rubber component.

9. The sealant composition according to claim 8, wherein the crosslinking agent comprises a sulfur component.

10. The sealant composition according to claim 8, wherein a blended amount of the crosslinking agent is from 50 mass % to 400 mass % of a blended amount of the crosslinking aid.

11. The sealant composition according to claim 8, wherein the crosslinking aid is a thiazole-based compound or a thiuram-based compound.

12. The sealant composition according to claim 6, wherein the rubber component comprises butyl rubber, and a blended amount of the butyl rubber per 100 mass % of the rubber component is 10 mass % or more.

13. The sealant composition according to claim 12, wherein the butyl rubber comprises chlorinated butyl rubber, and a blended amount of the chlorinated butyl rubber per 100 mass % of the rubber component is 5 mass % or more.

14. A pneumatic tire comprising the sealant layer formed of the sealant composition according to claim 1.
